(19) United States
(12) Patent Application Publication
(10) Pub. No.: US 2003/0012399 A1
(43) Pub. Date: Jan. 16, 2003

(54) Filtering system for a pornographic movie and filtering method

(76) Inventor: Martin Wu, Taipei (TW)

Correspondence Address: RABIN & BERDO, P.C., Suite 500, 1101 14th Street, N.W., Washington, DC, 20005, US

(21) Appl. No.: 10/107,313

(22) Filed: Mar. 28, 2002

(30) Foreign Application Priority Data
Jul. 11, 2001 (TW) 90117014

(51) Int. Cl. G06K 9/00

(52) U.S. Cl. 382/100

(57) ABSTRACT

A filtering system and filtering method for a pornographic movie is used to filter the transmitted pornographic image data flow, wherein the image data stream includes pornographic picture. The filtering system for a pornographic movie includes an image fetching device and a pornographic picture discerning engine. The image fetching device receives an input of the image data stream and controls an output of the image data stream to a playing device. The image fetching device further includes a fetching unit, a duplicate unit, and an intercepting unit. The fetching unit is used to fetch the image data of the image data stream. The duplicate unit is used to copy the fetched image data as a duplicate image data, and export the duplicate image data to the pornographic picture discerning engine to perform the discerning process. When the duplicate image data is discerned by the pornographic picture discerning engine that the pornographic picture is included, the pornographic picture discerning engine transmits a control signal to the intercepting unit. The intercepting unit immediately intercepts the rest part of image data in the image data stream.

This application incorporates by reference Taiwanese application Serial No. 90117014, filed on Jul. 11, 2001.

### BACKGROUND OF THE INVENTION

1. Field of the Invention:

This invention is relating to a filtering system for pornographic information and the discriminating method for the system. More particularly, the invention is relating to filtering system for a pornographic movie and the discriminating method for the system.

2. Description of Related Art:

The development of network has brought us the fast and convenient communication environment and the information flow. Network has created a cyberspace with rich activities. Users can therefore freely play in it but the cyberspace also has encountered several problems, which are often encountered in the actual word. Recently, the network criminal events have gradually occurred in an increasing rate, and cause many attentions for the people in every fields. For example, the pornographic web sites, network fraudulent events, computer virus and so on are the typical network criminal events, wherein the pornographic web sites have particularly been flooding, and severely caused harm in body and mind for the adolescents. As the network has been widely used and the tools of network viewer have been greatly improved, the users are not necessary to have much of computer knowledge but can easily touch the pornographic information from lots of pornographic web sites without efforts. In addition, the cyberspace of the network has the unique secure property; the network users can easily hide their personal actual status and look for the pornographic information from the network. This situation even more causes the cyberspace of the network to be almost occupied by the pornographic information.

In order to let the adolescents be fully making use of the network resources but not be negatively affected by those harmful network information, and provide the right of choice for those people who do want to view this kind of harmful information, some filtering software have been currently sold in the market. The filtering software, such as network X-stop or SurfWatch and so on, can be installed on a computer used for connecting the network. The filtering software has an information bank with a large number of web sites. If the users intend to connect to the web site, which is one of the black list of the filtering software, it will occur that the connection does not succeed. In this manner, then it can filter more than ten thousand of pornographic web sites, file transfer protocol (FTP) centers, and news groups. However, if the filtering software does not constantly update the web site information, once the pornographic web sites change their network addresses or new pornographic web sites have been added, the filtering software still cannot effectively prevent the pornographic information from invading.

The pornographic network information includes words, pictures, and movies. However, due to the limitation of network transmitting speed, currently, only the local area network (LAN) in wide bandwidth manner can fast transmit a large amount of image information. In this situation, the pornographic information often transmitted in the wide area network usually includes the pornographic word and pornographic picture. The way of circulating the pornographic movies is to sell the compact disc to the interested buyers. As the wide bandwidth network gradually increases and the multimedia technology used in computer has been well developed, the pornographic movies or pornographic audio provided by the pornographic network information are much more infiltrative and cankerous than what the conventional pornographic magazine and the pornographic recording tape make. Therefore, in the near foreseeable future, no matter whether in digital type network or analog type network, the pornographic movies would be one of the new main roles transmitted in the network in the next pornographic wave.

### SUMMARY OF THE INVENTION

It is therefore an objective of the present invention to provide a filtering system and method for a pornographic movie, used to filter the transmitted pornographic image data stream.

In accordance with the foregoing and other objectives of the present invention, a filtering method for a pornographic movie is provided, used to filter the transmitted pornographic image data stream, wherein the image data stream includes pornographic picture. The filtering method for the pornographic movie includes first fetching image data from the image data stream. Then, the fetched image data is copied as a duplicate image data. Then, the duplicate image data is discerned to known whether or not it includes pornographic picture. Finally, when the duplicate image data is discerned out that it includes pornographic picture, the rest part of the image data of the image data stream is intercepted.

In accordance with another objective of the present invention, a filtering system for a pornographic movie is provided, used to filter the transmitted pornographic image data flow, wherein the image data stream includes pornographic picture. The filtering system for a pornographic movie includes an image fetching device and a pornographic picture discerning engine. The image fetching device receives an input of the image data stream and controls an output of the image data stream to a playing device. The image fetching device further includes a fetching unit, a duplicate unit, and an intercepting unit. The fetching unit is used to fetch the image data of the image data stream. The duplicate unit is used to copy the fetched image data as a duplicate image data, and export the duplicate image data to the pornographic picture discerning engine to perform the discerning process. When the duplicate image data is discerned by the pornographic picture discerning engine that the pornographic picture is included, the pornographic picture discerning engine transmits a control signal to the intercepting unit. The intercepting unit immediately intercepts the rest part of image data in the image data stream.

### BRIEF DESCRIPTION OF DRAWINGS

The invention can be more fully understood by reading the following detailed description of the preferred embodiments, with reference made to the accompanying drawings, wherein:

FIG. 1 is a block diagram, schematically illustrating a filtering system for a pornographic movie, according to preferred embodiment of the present invention; and

FIG. 2 is process flow diagram, schematically illustrating a filtering method for a pornographic movie, according to preferred embodiment of the present invention.

### DETAILED DESCRIPTION OF PREFERRED EMBODIMENTS

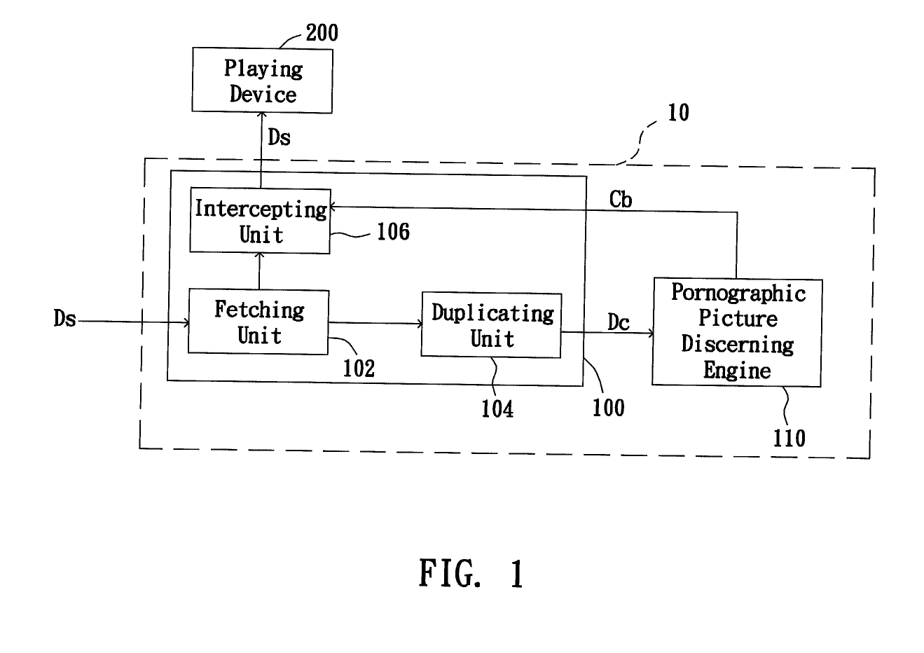

FIG. 1 is a block diagram, schematically illustrating a filtering system for a pornographic movie, according to preferred embodiment of the present invention. In FIG. 1, the filtering system 10 for pornographic movies is used to filter the image data stream with pornographic picture. The filtering system includes an image fetching device 100, and a pornographic picture discerning engine 110. The image data stream Ds, such as the data streams of MPEG or AVI, is transmitted to the image fetching device 100 through network, such as a digital type network or an analog type network. Then, the image fetching device 100 controls the output of the image data stream Ds to a playing device 200, wherein the playing device 200 can be an application program in types of, for example, playing program or a viewer. The image fetching device 100 further includes a fetching unit 102, a duplicate unit 104, and an intercepting unit 106. The fetching unit 102 is used to fetch the image data of the image data stream. The duplicate unit 104 is used to copy the fetched image data as a duplicate image data Dc, and export the duplicate image data Dc to the pornographic picture discerning engine 110 to perform the discerning process. When the duplicated image data Dc is discerned by the pornographic picture discerning engine 110 in which the data Dc include the pornographic picture, the pornographic picture disceming engine 110 transmits a control signal Cb to the intercepting unit 106. The intercepting unit 106 immediately intercepts the rest part of image data in the image data stream Ds. In the present invention, the filtering system 10 for the pornographic movie can be installed on any place where the image data stream Ds can flow through, such as a set-up-box.. Then, the porn image data stream is separated out by the engine and an interception is performed.

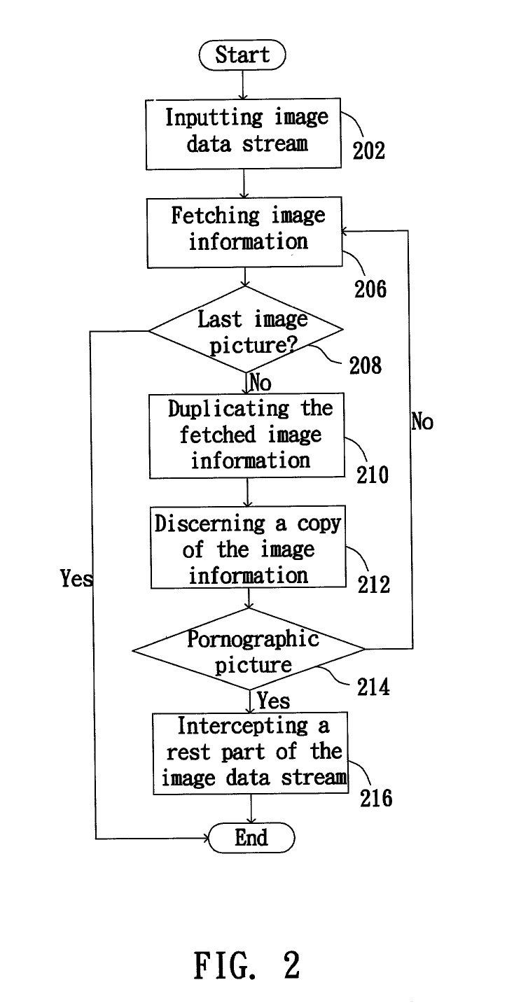

FIG. 2 is a process flow diagram, schematically illustrating a filtering method for a pornographic movie, according to preferred embodiment of the present invention. In FIG. 2, the filtering method for a pornographic picture is used to filter the transmitted pornographic image data stream. In step 202, an image data stream Ds is inputted to the image fetching device 100. The image fetching device 100 export the image data stream Ds to the playing device 200. When it at the same time that the image data stream Ds continuously exports to the application program, such as playing program or viewer, the fetching unit 102, in step 206, performs spot check on the fetched image data. Due to the image data stream Ds usually has the rate with about 30 pictures per second, and the picture would have no much difference in one second. Therefore, the fetched picture in spot check from the image data stream Ds is sufficient to actually reflect the actual scene of the movie. The spot check manner takes that the full and complete image is sampled out in a time interval or the number interval of image frames interval, so as to fetch the complete image, such as one picture per second or one image fetched for every 30 image. In this manner, the fetched image data is a static picture. After continuously taking five seconds, the fetching action stops for fifty five seconds. Then, the fetched image data is an acting image data, including several image pictures. When the fetched pictures have a larger number, it can improve the discerning rate. Then, in step 208, the fetched image data is judged whether or not the image data stream Ds is the last picture. If it is, then the filtering method ends. If it is not, the process goes to the step 210

In step 210, the duplicate unit 104 duplicates the fetched image data as a duplicate image data Dc, and exports the duplicate image data Dc to the pornographic picture discerning engine 110. At the same time, the image data stream Ds is continuously exported to the pornographic picture discerning engine 110. However, in step 212, the pornographic picture discerning engine 110 performs the discerning process on the duplicate data Dc. Due to the pornographic picture usually including many sexy poses, partial or full nude scenes, the pornographic picture discerning engine 110 can use the skin color filling ratio as a discerning manner. In step 214, if the pornographic picture discerning engine 110 does not find that the duplicate image data Dc includes the pornographic picture, then the process returns to the step 206. The fetching unit 102 continuously fetches the image data stream in spot check manner. If the pornographic picture discerning engine 110 does find that the duplicate image data Dc includes the pornographic picture, such as a skin color filling ratio is detected as a large quantity, the image data stream Ds is judged as a pornographic movie. The pornographic picture discerning engine 110 then sends a control signal Cb to the image intercepting device 100 and informs the image intercepting device 100 to stop transmitting the image data stream Ds to the playing unit 106. After then as shown in step 216, the intercepting unit 106 immediately intercepts the rest part of the image data. After the rest part of the image data of the image data stream is intercepted, the playing device 200 stops playing the image data stream, so as to achieve the discerning and the intercepting functions for the pornographic movies in network. The filtering method for the pornographic movie is end.

The foregoing preferred embodiment of the present invention has disclosed a filtering system and a filtering method for a pornographic movie. It uses the image fetching device to fetch the imaging picture of the image data stream in spot check, and then the pornographic picture discerning engine does directly discern the fetched image picture to judge whether or not the image data stream is a pornographic movie. The invention can filter the transmitted image data stream, control the output of the image data stream, and then achieve the filtering and intercepting function for the pornographic movies on the adult pornographic image information. As a result, adolescents can fully make use of the network resources, and are not be negatively affected by the harmful information on the internet. The invasion of pornographic image information can therefore be effectively avoided.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A filtering method for a pornographic movie, used to filter a transmitted image data stream, wherein the image data stream includes at least a pornographic picture, the filtering method for the pornographic movie comprising:
fetching an image information from the image data stream;
duplicating the fetched image information to have a copy of the image information;
discerning the copy of the image information; and
intercepting a rest part of the image data stream.

2. The filtering method for the pornographic movie according to claim 1, wherein the image information of the image data stream is fetched by a spot check manner.

3. The filtering method for the pornographic movie according to claim 2, wherein the spot check manner includes taking a time interval for sampling.

4. The filtering method for the pornographic movie according to claim 2, wherein the spot check manner includes taking the number interval of image frames for sampling.

5. The filtering method for the pornographic movie according to claim 2, wherein the fetched image information includes a static image picture.

6. The filtering method for the pornographic movie according to claim 2, wherein the fetched image information is a dynamic image information, including a plurality of image pictures in sequence.

7. The filtering method for the pornographic movie according to claim 1, before the step of fetching the image information from the image data stream, further comprising inputting the image data stream to an image fetching device.

8. The filtering method for the pornographic movie according to claim 7, wherein after the image data stream is input to the image fetching device, the image data stream is then exported to a playing device.

9. The filtering method for the pornographic movie according to claim 8, wherein the playing device is a playing program.

10. The filtering method for the pornographic movie according to claim 8, wherein the playing device is a viewer.

11. The filtering method for the pornographic movie according to claim 8, wherein the copy of the image information is exported to a pornographic picture discerning engine for discerning.

12. The filtering method for the pornographic movie according to claim 11, wherein when the pornographic picture discerning engine discerns out that the copy of the image information includes the pornographic picture, the pornographic picture discerning engine informs the image fetching device to intercept the rest part of the image data stream.

13. The filtering method for the pornographic movie according to claim 12, wherein after the rest part of the image data stream is intercepted, the playing device immediately stop playing the image data stream.

14. The filtering method for the pornographic movie according to claim 11, wherein the pornographic picture discerning engine uses a skin color filling ratio as a discerning feature.

15. A filtering system for a pornographic movie, used to filter an image data stream with at least a pornographic picture, the filtering system for the pornographic movie comprising:
an image fetching device, used to receive an input of the image data stream, and control an output for the image data stream to a playing device, the image fetching device comprising:
a fetching unit, used to fetch an image information of the image data stream;
a duplicating unit, used to duplicate the fetched image information to have a copy of the image information, and
an intercepting unit, used to intercept a rest part of the image data stream; and
a pornographic picture discerning engine, use to discern the copy of the image information, and transmit a control signal to the intercepting unit.

16. The filtering system for the pornographic movie according to claim 15, wherein the image data stream is transmitted through a network.

17. The filtering system for the pornographic movie according to claim 16, wherein the network is a digital type network.

18. The filtering system for the pornographic movie according to claim 16, wherein the network is an analog type network.

19. The filtering system for the pornographic movie according to claim 15, wherein the image fetching unit takes a spot check manner to fetch the image information of the image data stream.

20. The filtering system for the pornographic movie according to claim 19, wherein the spot check manner is taking a time interval for sampling.

21. The filtering system for the pornographic movie according to claim 19, wherein the spot check manner is taking a number interval of image frames for sampling.

22. The filtering system for the pornographic movie according to claim 19, wherein the fetched image information is a static image picture.

23. The filtering system for the pornographic movie according to claim 19, wherein the fetched image information is a dynamic image picture in sequence.

24. The filtering system for the pornographic movie according to claim 15, wherein the displaying device includes a playing program.

25. The filtering system for the pornographic movie according to claim 15, wherein the displaying device includes a viewer.
